(19) United States
(12) Patent Application Publication
(10) Pub. No.: US 2004/0150669 A1
(43) Pub. Date: Aug. 5, 2004

(54) Graphical user interface for describing the state of a managed system

(76) Inventors: Mark L. Sabiers, Fort Collins, CO (US); Debbie Lienhart, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/356,206

(22) Filed: Jan. 31, 2003

(51) Int. Cl. G09G 5/00

(52) U.S. Cl. 345/781

(57) ABSTRACT

A graphical user interface for describing a state of a managed system comprising a first view and a second view. The first view is for rendering a first role-specific annotation for a first role which describes the state of the managed system using a first vocabulary, wherein the first view is selectable in response to a first user request. The second view is for rendering a second role-specific annotation for a second role which describes the state of the managed system using a second vocabulary, wherein the second view is selectable in response to a second user request.

### FIELD OF INVENTION

Various embodiments of the present invention relate to the field of graphical user interfaces.

### BACKGROUND OF THE INVENTION

As the use of computing technology continues to expand in the business world, managed systems such as distributed computer networks and enterprise systems are becoming more prevalent. In general, a managed system is a computing system that collects data against its own execution, and uses the data to manage its operation. A typical managed system is an enterprise system implementing Web services.

Web services systems typically comprise a distributed system of independent threads of execution on multiple computers. In the event of a distributed data collection problem, the data can be used to perform an analysis and report on the problem. Often, Web services systems are so distributed and complex that people in different roles need to be able to communicate with each other in great detail. Communication between people in different roles may be difficult due to their varying backgrounds and vocabularies.

For example, a distributed collection of computer servers may be used to back a shopping Web site. In managing a typical shopping Web site, people with a number of different roles are employed. Often, business managers, information technology (IT) personnel/operators and software developers all concerned with the state or performance of a system. Web sites backed by Web services typically require people having different roles to communicate with each other. For example, business management may communicate with IT personnel regarding Web site performance. In turn, the IT personnel may communicate with development to resolve Web site performance issues.

Often, due to the fast pace of business, it is necessary for people in different roles to communicate with each other very quickly. For example, a software product release may require last minute changes. In situations requiring tight turnaround times, communication must occur very fast to make changes or enhancements to the system.

Currently, Web services systems provide a single model for their data. People in each role are provided with data that corresponds to their respective roles. While a user may have access to the data of another role with which they need to communicate, the data is presented using the vocabulary of the other role. As described above, due to the different backgrounds and vocabularies of users in different roles, the data of a user in a different role will typically not provide a user with an effective means of understanding the other role. In a situation requiring tight turnaround time, people in different roles often find it difficult to communicate with each other.

### SUMMARY OF THE INVENTION

Various embodiments of the present invention, a graphical user interface for describing a state of a managed system are presented. In one embodiment the graphical user interface comprises a first view and a second view. The first view is for rendering a first role-specific annotation for a first role which describes the state of the managed system using a first vocabulary, wherein the first view is selectable in response to a first user request. The second view is for rendering a second role-specific annotation for a second role which describes the state of the managed system using a second vocabulary, wherein the second view is selectable in response to a second user request.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates steps in a process for rendering a graphical user interface in accordance with one embodiment of the present invention.

FIG. 2A illustrates a first view of a graphical user interface in accordance with one embodiment of the present invention.

FIG. 2B illustrates a second view of a graphical user interface in accordance with one embodiment of the present invention.

FIGS. 3A, 3B and 3C illustrate an exemplary graphical user interface having three view in accordance with one embodiment of the present invention.

FIG. 4 illustrates steps in a process for mapping a portion of a first role-specific annotation into a second role-specific annotation in accordance with one embodiment of the present invention.

FIG. 5 illustrates a mapping view for mapping data from a first view to a second view in accordance with one embodiment of the present invention.

### BEST MODE(S) FOR CARRYING OUT THE INVENTION

Reference will now be made in detail to various embodiments of the invention, examples of which are illustrated in the accompanying drawings. While the invention will be described in conjunction with various embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention. However, it will be apparent to one skilled in the art that the present invention may be practiced without these specific details. In other instances, well-known methods, procedures, components, structures and devices have not been described in detail so as to avoid unnecessarily obscuring aspects of the present invention.

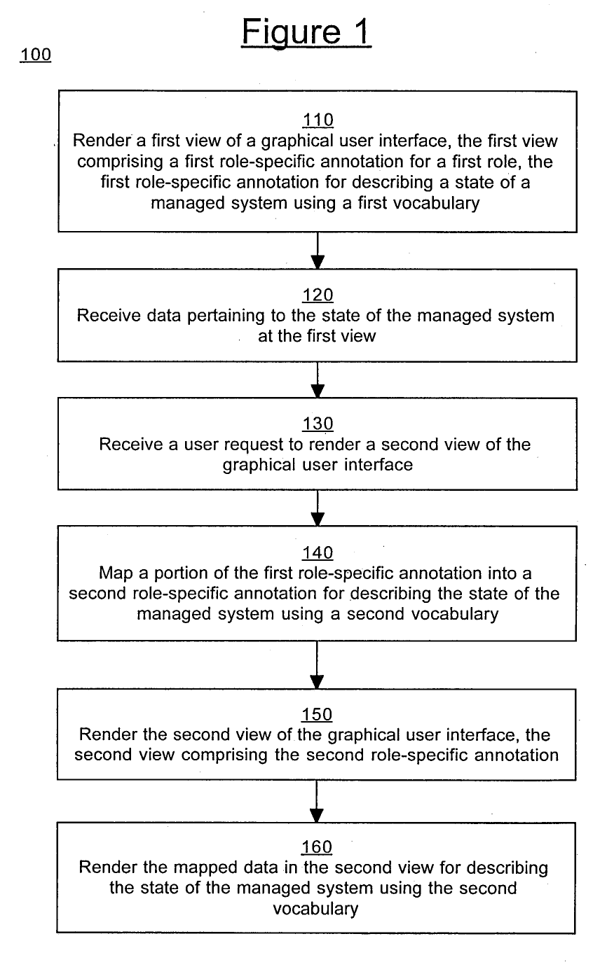

FIG. 1 is a flowchart illustrating a process 100 for rendering a graphical user interface in accordance with one embodiment of the present invention. In one embodiment, process 100 is carried out by processors and electrical components under the control of computer readable and computer executable instructions. Although specific steps are disclosed in process 100, such steps are exemplary. That is, the embodiments of the present invention are well suited to performing various other steps or variations of the steps recited in FIG. 1.

At step 110 of process 100, a first view of a graphical user interface (GUI) for describing the state of a managed system is rendered. In one embodiment, the GUI renders role-specific annotations for a plurality of roles. A role describes a particular user or set of users that are concerned with one aspect of the performance of the managed system. In one embodiment, roles may include, but are not limited to, business (e.g., business management, advertising, finance), operations (e.g., information technology personnel), and development (e.g., software development). In one embodiment, the managed system is an enterprise system operable to provide Web services.

In one embodiment of the present invention, the GUI renders a personalized GUI for a particular user. On startup, the GUI determines which user is logged on and determines which role they are interested in viewing. In one embodiment, the personalization data for the user is accessed to determine which role is rendered.

In one embodiment, the managed system is an enterprise system operable to provide Web services. In one embodiment, the Web services back a shopping Web site. In one embodiment, the managed system is monitored by a plurality of roles of users. For example, in the present embodiment, business managers may be interested in the business aspects of system performance, information technology (IT) operators may be interested in operations aspects of system performance, and software developers may be interested in the development aspects of system performance.

In one embodiment, a role is associated with a particular role-specific annotation. A role-specific annotation comprises information specific to a particular role. In one embodiment, a role-specific annotation is comprised of a particular vocabulary and/or metrics. A role-specific annotation is used for presenting information specific to a particular role using the vocabulary and/or metrics associated with that role. In one embodiment, a role-specific annotation further comprises graphical representations to convey information in the mental model understood best by the particular role. For purposes of the present application, the term vocabulary generally refers to terminology, metrics, and graphical representations for conveying information to a particular role.

In one embodiment, the first view of the GUI comprises a first role-specific annotation for a first role, wherein the first role-specific annotation for describes a state of the managed system using a first vocabulary. It should be appreciated that a role-specific annotation may be formatted in any way to present useful information in a desirable manner. In one embodiment, the content of a role-specific annotation is data-driven according to a particular role, such that the view is rendered in a manner best understood by the particular role.

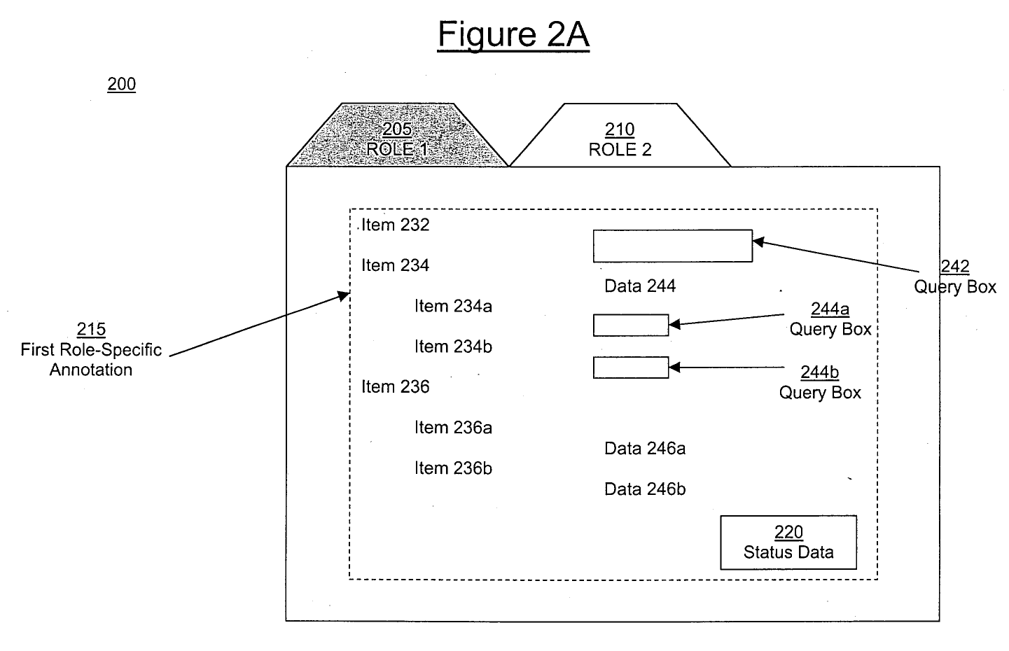

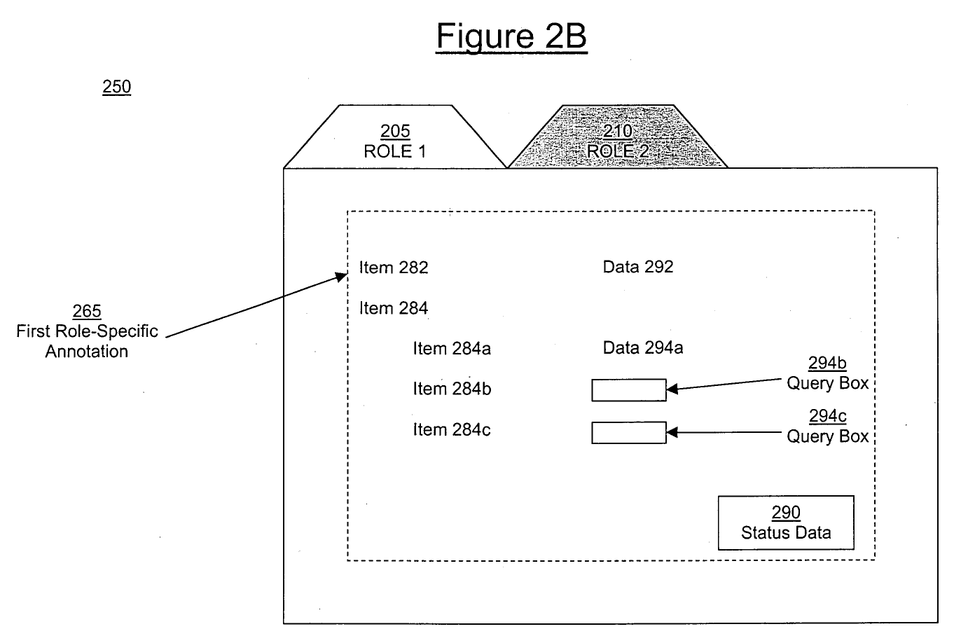

FIG. 2A illustrates a first view 200 of a GUI in accordance with one embodiment of the present invention. First view 200 comprises first role-specific annotation 215 for a first role using a first vocabulary. First role-specific annotation 215 comprises a plurality of fields (e.g., items, data, and query boxes). For purposes of the present application, an item refers to information describing an aspect of performance of a managed system. An item may describe another item or sub-item, data or a query box. Data refers to information that describes performance of the managed system. It should be appreciated that data may be qualitative or quantitative. Query boxes refer to locations where data is entered into the GUI.

It should be appreciated that first role-specific annotation 215 is data-driven, such that all fields (e.g., items, data, and query boxes) are determined according to user-defined data. It should also be appreciated that information rendered may be graphic representations such as block diagrams, tables spreadsheets, graphs and other figures to convey role-specific information to a user.

In the present embodiment, first role-specific annotation 215 comprises items 232, 234 and 236 which describe particular information concerning the performance of a managed system. Similarly, items 234a and 234b are sub-items of item 234 and items 236a and 236b are sub-items of item 236. As described above, the information rendered in the items and sub-items are defined according to user-defined data.

In one embodiment, associated with a portion of the items are data for presenting information and query boxes for receiving information. For example, item 232 is associated with query box 242, item 234a is associated with query box 244a, and item 234b is associated with query box 244b. Also, item 234 is associated with data 244, item 236a is associated with 246a, and item 236b is associated with 246b. It is not necessary for an item to be associated with data or a query box, as shown at item 236.

First view 200 also comprises, in one embodiment, selectable tabs 205 and 210 for selecting a view for a particular role. In another embodiment, a view is selected by accessing a drop-down menu. In another embodiment, a view is selected by selecting a selectable element of the GUI. It should be appreciated that view selection may be implemented in any way used for rendering different windows of information, and is not limited by the aforementioned embodiments.

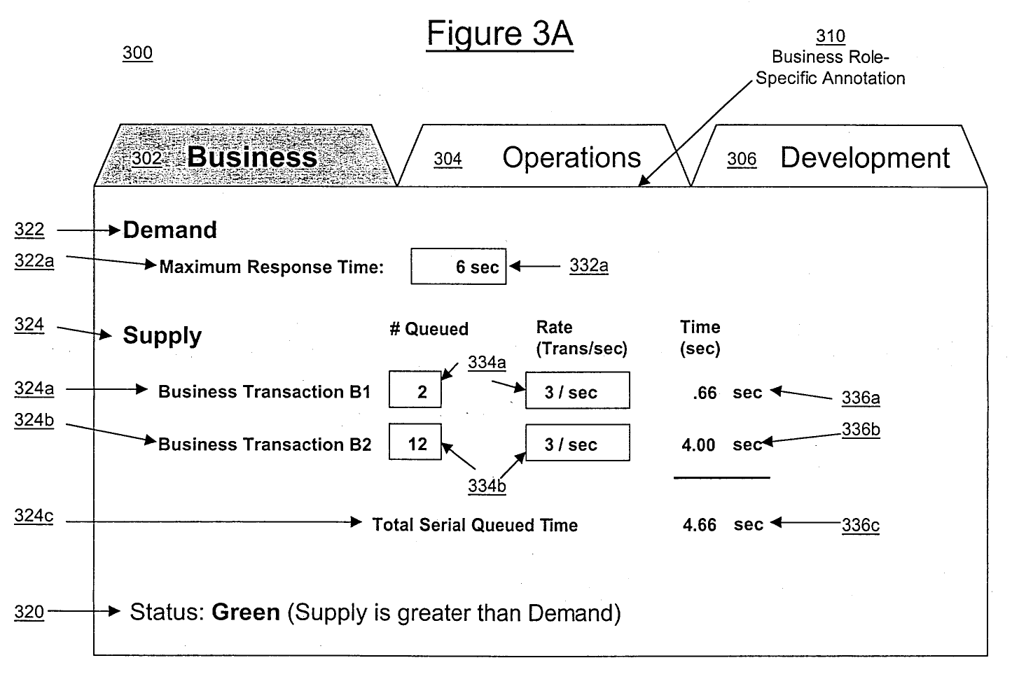

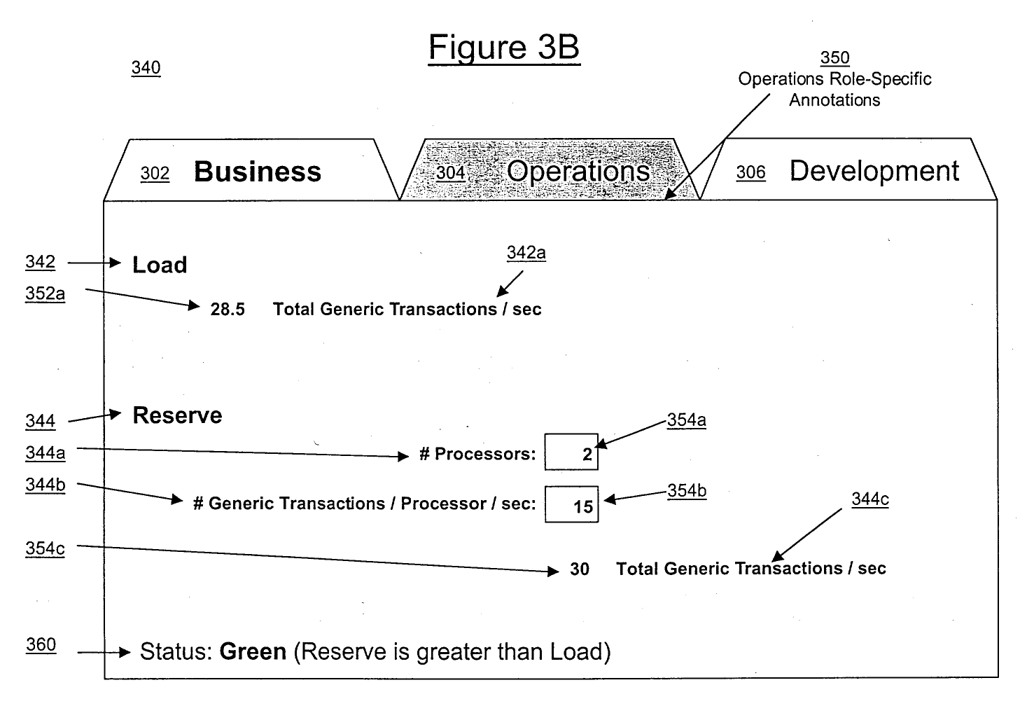

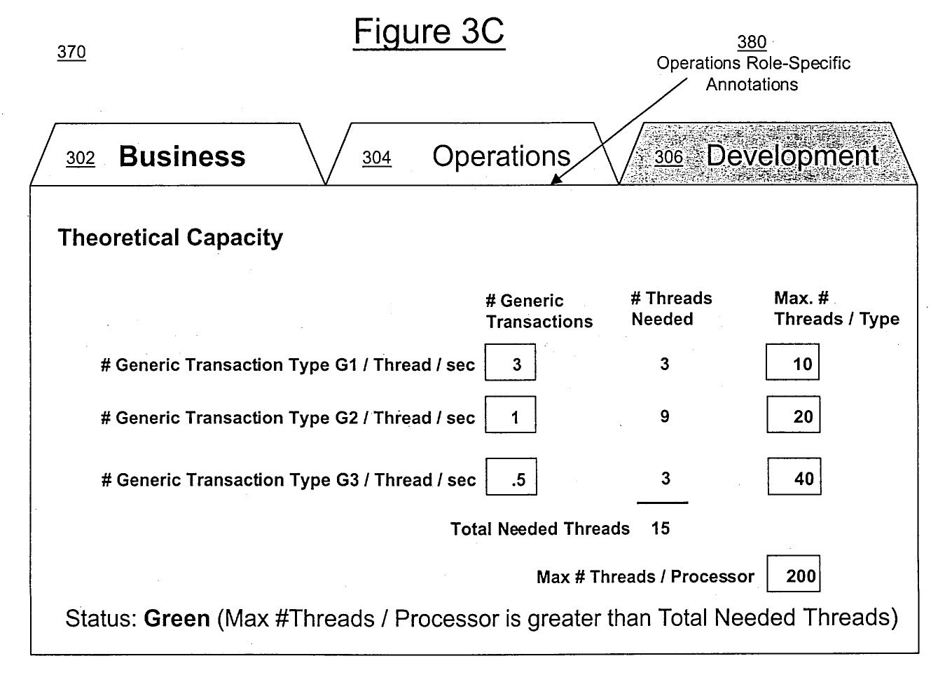

FIGS. 3A, 3B and 3C illustrate an exemplary GUI having three views in accordance with one embodiment of the present invention. In one embodiment, the GUI is used to manage a Web services system backing a shopping Web site. FIG. 3A illustrates business view 300 of an exemplary GUI. Business view 300 comprises business role-specific annotation 310. It should be appreciated that the contents of business role-specific annotation 310 is data-driven, such that any information desired by a user in a business role can be rendered. In the present embodiment, business role-specific annotation 310 is designed to render information based on the concept of demand and supply. It should be appreciated that business role-specific annotation 310 can be based on any concept desirable from a business perspective, such as profit and loss, advertising, and finance, and is not limited to the present embodiment.

In the present embodiment, business view 300 presents business role-specific annotation 310 from the perspective of supply and demand. A user in a business role (e.g., a business manager) determines a maximum response time for transaction received on the Web site. Business role-specific annotation 310 comprises item 322 (e.g., demand) and item 324 (e.g., supply). Item 322 comprises a single sub-item, item 322a (e.g., maximum response time) that corresponds to query box 332a (e.g., 6 sec).

Item 324 comprises item 324a (e.g., business transaction B1), item 324b (e.g., business transaction B2), and item 324c (e.g., total serial queued time). Item 324a corresponds to query boxes 334a and data 336a, item 324b corresponds to query boxes 334b and data 336b, and item 324c corresponds to data 336c.

With reference to FIG. 1, at step 120, data pertaining to the state of the managed system is received at the first view. In one embodiment, the data is associated with the first vocabulary. In one embodiment, a user enters the data into a query box (e.g., query box 242 of FIG. 2A). The user, by viewing the first view, enters data corresponding to the first vocabulary.

With reference to FIG. 3A, business view 300 allows the business role to dictate a maximum response time for Web site transaction, and to determine whether the maximum response time is being exceeded. In the present embodiment, the maximum response time was defined as 6 seconds (e.g., query box 332a). The Web site is designed to perform two types of business transactions (e.g., B1 and B2). Query boxes 334a and 334b comprise information used to calculate the total response time for each type of business transaction, as shown at data 336a and data 336b, respectively. The information entered into query boxes 334a and 334b are based on operational data, and may be manually entered or automatically entered based on information received at an operational view (e.g., operations view 340 of FIG. 3B).

In the present embodiment, the total serial queued time is calculated at 4.66 seconds at data 336c. Since the value of data 336c is less than the value of query box 332a, status data 320 (e.g., green) indicates that the maximum response time is not being exceeded.

With reference to FIG. 1, at step 130, a user request is received to render a second view of the GUI. In one embodiment, the user request is received in response to a selection of a selectable tab (e.g., selectable tab 210 of FIG. 2A). In one embodiment, the selectable tabs are generated based on personalization data for a user. For example, the personalization data indicates which roles a user is interested in viewing or has access to view, with only these roles rendered as selectable tabs. In another embodiment, all roles of the GUI are rendered as selectable tabs.

With reference to FIG. 1, at step 140, a portion of the first-role specific annotation is mapped into a second role-specific annotation for describing the state of the managed system in a second vocabulary. In one embodiment, a portion of a business view (e.g., business view 300 of FIG. 3A) is mapped into an operations view (e.g., operations view 340 of FIG. 3B).

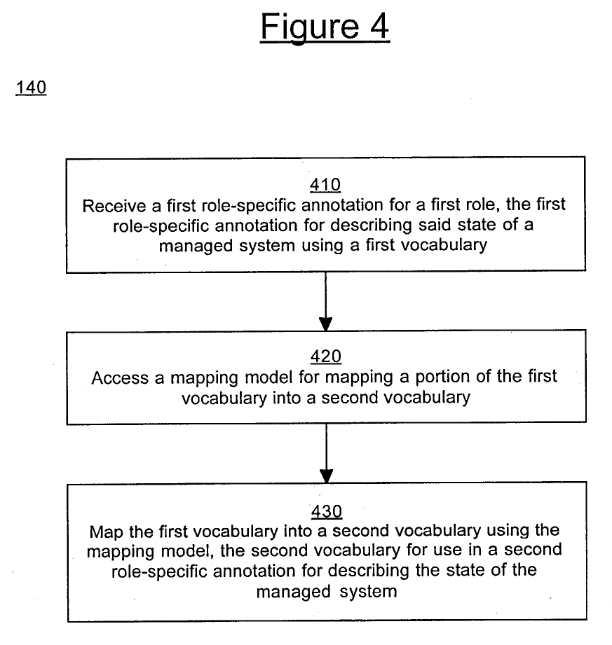

FIG. 4 illustrates steps in a process 140 for mapping a portion of a first role-specific annotation into a second role-specific annotation in accordance with one embodiment of the present invention. In one embodiment, process 400 is carried out by processors and electrical components under the control of computer readable and computer executable instructions. Although specific steps are disclosed in process 400, such steps are exemplary. That is, the embodiments of the present invention are well suited to performing various other steps or variations of the steps recited in FIG. 4.

At step 410 of process 140, a first role-specific annotation for a first role is received, wherein the first role-specific annotation describes the state of a managed system using a first vocabulary. As described above, the first role-specific annotation comprises information (e.g., items and data) in a first vocabulary for understanding of a user in the first role.

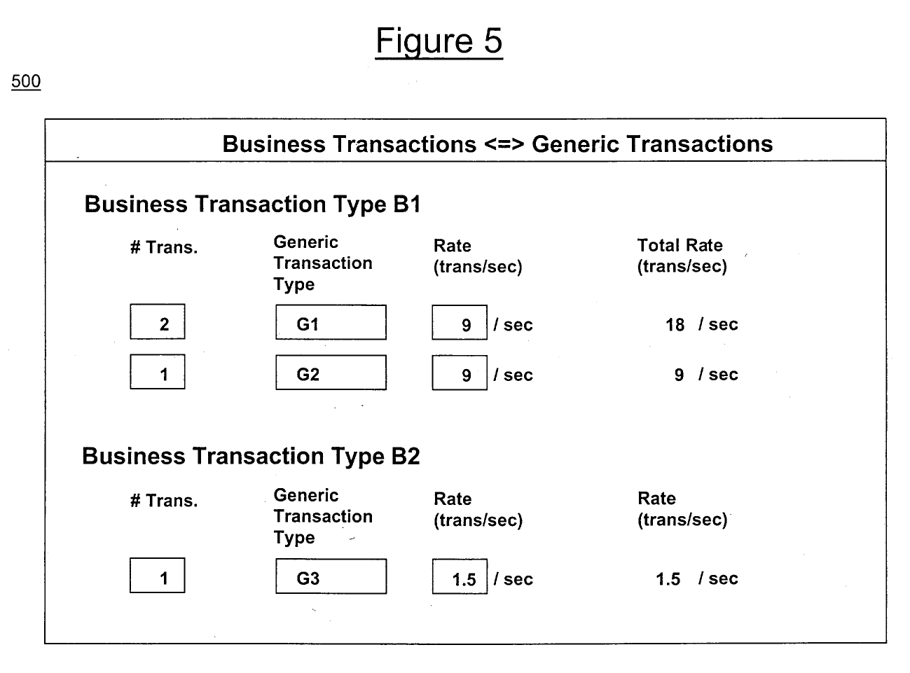

At step 420, a mapping model is accessed for mapping a portion of the first role-specific annotation into a second role-specific annotation. FIG. 5 illustrates a mapping view 500 of a GUI for mapping data from a first view to a second view in accordance with one embodiment of the present invention. In particular, mapping view 500 illustrates the mapping from business view 300 of FIG. 3A into operations view 340 of FIG. 3B.

It should be appreciated that a mapping model may vary in complexity. In one embodiment, a one to one mapping model is used, wherein different terms name different quantities in different units related by mathematical transformations. For example, a one to one mapping might map two different terms that having the same meaning. In another embodiment, a mapping model having more complex levels may be used, such as n to one or n to n mappings, where n is an integer greater than one, within the same concepts or across conceptual boundaries.

As described at FIG. 3A, the exemplary Web site is designed to support two types of business transactions, B1 and B2. In order to manage the performance if the system, operations (e.g., IT personnel) are interested in transactional rates. Therefore, the business transaction must be mapped into generic transactions to determine the total rate of generic transactions per second.

With respect to business transaction type B1, two types of generic transactions must be performed, G1 and G2. In particular, generic transaction type G1 must be performed twice. Since both generic transactions types G1 and G2 are performed at the rate of 9 transactions per second and type G1 is performed twice, business transaction type B1 require 27 transactions per second. Similarly, transaction type B2 requires 1.5 transactions per second.

With reference to FIG. 4, at step 430, the first vocabulary is mapped into a second vocabulary using the mapping model, wherein the second role-specific annotation describes the state of the managed system using the second vocabulary.

With reference to FIG. 1, at step 150 of process 100, a second view is rendered, wherein the second view comprises the second role-specific annotation. FIG. 2B illustrates a second view 250 of a GUI in accordance with one embodiment of the present invention. Second view 250 comprises second role-specific annotation 265 for a second role using a second vocabulary. Second role-specific annotation 265 comprises a plurality of fields (e.g., items, data, and query boxes). It should be appreciated that second role-specific annotation 265 is data-driven, such that all fields (e.g., items, data, and query boxes) are determined according to user-defined data. It should also be appreciated that information rendered may be graphic representations such as block diagrams, tables spreadsheets, graphs and other figures to convey role-specific information to a user.

In the present embodiment, second role-specific annotation 265 comprises items 282 and 284 which describe particular information concerning the performance of a managed system using a second vocabulary. Items 284a-c are sub-items of item 284. As described above, the information rendered in the items and sub-items are defined according to user-defined data.

In one embodiment, associated with a portion of the items are data for presenting information and query boxes for receiving information. For example, item 282 is associated with data 292 and item 284a is associated with data 294a. Also, item 284b is associated with query box 294b, and item 284c is associated with query box 294c. It is not necessary for an item to be associated with data or a query box, as shown at item 284.

Second view 250 also comprises, in one embodiment, selectable tabs 205 and 210 for selecting a view for a particular role. In another embodiment, a view is selected by accessing a drop-down menu. In another embodiment, a view is selected by selecting a selectable element of the GUI. It should be appreciated that view selection may be implemented in any way used for rendering different windows of information, and is not limited by the aforementioned embodiments.

With reference to FIG. 3A, a user interacting with selectable tab 304 results in the rendering of an operations view of the GUI (e.g., operations view 340 of FIG. 3B). Similarly, a user interacting with selectable tab 306 results in the rendering of a development view of the GUI (e.g., development view 370 of FIG. 3C).

With reference to FIG. 3B, operations view 340 of an exemplary GUI is illustrated. Operations view 340 comprises operations role-specific annotation 350. It should be appreciated that the content of operations role-specific annotation 350 is data-driven, such that any information desired by a user in an operations role can be rendered. In the present embodiment, operations role-specific annotation 350 is designed to render information based on the concept of load and reserve. It should be appreciated that operations role-specific annotation 350 can be based on any concept desirable from an operations perspective, and is not limited to the present embodiment.

In the present embodiment, operations view 340 presents operations role-specific annotation 350 from the perspective of load and reserve. A user in an operations role (e.g., IT personnel) is presented with information indicating whether reserve computing capacity exceeds the load. Operations role-specific annotation 350 comprises item 342 (e.g., load) and item 344 (e.g., reserve). Item 322 comprises a single sub-item, item 342a (e.g., total generic transactions/sec) that corresponds to data 352a (e.g., 28.5).

Item 344 comprises item 344a (e.g., # of processors), item 344b (e.g., # generic transactions/processor/sec), and item 344c (e.g., total generic transactions/sec). Item 344a corresponds to query box 354a, item 344b corresponds to query box 354b, and item 344c corresponds to data 354c.

With reference to FIG. 3C, development view 370 of an exemplary GUI is illustrated. Development view 370 comprises development role-specific annotation 380. It should be appreciated that the content of development role-specific annotation 380 is data-driven, such that any information desired by a user in a development role can be rendered. In the present embodiment, development role-specific annotation 380 is designed to render information based on the concept of theoretical capacity. It should be appreciated that development role-specific annotation 380 can be based on any concept desirable from a software development perspective, and is not limited to the present embodiment.

With reference to FIG. 1, at step 160, the mapped data is rendered in the second view. With reference to FIG. 3B, the total generic transactions per second (e.g., item 342a) is given as 28.5 (e.g., data 352a). Data 352a is the total of the 27 transactions per second for business transaction type B1 and the 1.5 transactions per second for business transaction type B2. The total generic transactions per second is mapped to data 352a.

Various embodiments of the present invention, a graphical user interface for describing a state of a managed system, are thus described. While the present invention has been described in particular embodiments, it should be appreciated that the present invention should not be construed as limited by such embodiments, but rather construed according to the below claims.

What is claimed is:

1. A graphical user interface for describing a state of a managed system comprising:
a first view for rendering a first role-specific annotation for a first role which describes said state of said managed system using a first vocabulary, wherein said first view is selectable in response to a first user request; and
a second view for rendering a second role-specific annotation for a second role which describes said state of said managed system using a second vocabulary, wherein said second view is selectable in response to a second user request.

2. The graphical user interface as recited in claim 1 wherein said first view is operable to receive data for describing said state of said managed system using said first vocabulary.

3. The graphical user interface as recited in claim 2 wherein said data is mapped into mapped data for describing said state of said managed system using said second vocabulary at a mapping interface.

4. The graphical user interface as recited in claim 3 further comprising a mapping view for rendering a portion of said mapping interface.

5. The graphical user interface as recited in claim 3 wherein said second view is operable to render said mapped data for describing said state of said managed system using said second vocabulary.

6. The graphical user interface as recited in claim 1 wherein said managed system is an enterprise system operable to provide web services.

7. The graphical user interface as recited in claim 1 further comprising a first selectable tab and a second selectable tab, wherein said first view is rendered in response to a user selecting said first selectable tab, and said second view is rendered in response to a user selecting said second selectable tab.

8. The graphical user interface as recited in claim 1 wherein said first role is a business role, said first vocabulary is a business vocabulary, said second role is an operations role, and said second vocabulary is an operations vocabulary.

9. The graphical user interface as recited in claim 1 wherein said first view and said second view are data-driven.

10. A method for rendering a graphical user interface, said method comprising:
rendering a first view, said first view comprising a first role-specific annotation for a first role, said first role-specific annotation for describing a state of a managed system using a first vocabulary;
in response to a user request, mapping a portion of said first role-specific annotation into a second role-specific annotation for describing a state of a managed system using a second vocabulary; and
rendering a second view, said second view comprising said second role-specific annotation for a second role.

11. The method as recited in claim 10 further comprising receiving data for describing said state of said managed system using said first vocabulary.

12. The method as recited in claim 11 further comprising mapping said data into mapped data for describing said state of said managed system using said second vocabulary.

13. The method as recited in claim 12 further comprising rendering said mapped data for describing said state of said managed system using said second vocabulary in said second view.

14. The method as recited in claim 10 wherein said managed system is an enterprise system operable to provide web services.

15. The method as recited in claim 10 wherein said first role is a business role, said first vocabulary is a business vocabulary, said second role is an operations role, and said second vocabulary is an operations vocabulary.

16. A computer-readable medium having computer-readable program code embodied therein for causing a computer system to perform a method of describing a state of a managed system, said method comprising:
receiving a first role-specific annotation for a first role, said first role-specific annotation for describing said state of said managed system using a first vocabulary;
accessing a mapping model for mapping a portion of said first role-specific annotation into a second role-specific annotation using a second vocabulary;
mapping said first vocabulary into said second vocabulary using said mapping model, said second role-specific annotation describing said state of said managed system using said second vocabulary.

17. The computer-readable medium as recited in claim 16 further comprising, in response to a first user request, rendering a first view of a graphical user interface, said first view for rendering said first role-specific annotation for said first role.

18. The computer-readable medium as recited in claim 17 further comprising, in response to a second user request, rendering a second view of said graphical user interface, said second view for rendering said second role-specific annotation for said second role.

19. The computer-readable medium as recited in claim 16 wherein said managed system is an enterprise system operable to provide web services.

20. The computer-readable medium as recited in claim 16 wherein said first role is a business role, said first vocabulary is a business vocabulary, said second role is an operations role, and said second vocabulary is an operations vocabulary.
